(19) United States
(12) Patent Application Publication
(10) Pub. No.: US 2026/0023213 A1
(43) Pub. Date: Jan. 22, 2026

(54) INTEGRATED PHOTONIC DEVICES FOR MID-WAVE INFRARED WAVELENGTHS

(71) Applicant: RTX BBN Technologies, Inc., Cambridge, MA (US)

(72) Inventors: Milica Notaros, Arlington, MA (US); Moe D. Soltani, Belmont, MA (US)

(21) Appl. No.: 19/276,991

(22) Filed: Jul. 22, 2025

Related U.S. Application Data
(60) Provisional application No. 63/674,076, filed on Jul. 22, 2024.

(51) Int. Cl. G02B 6/10; G02B 6/293

(52) U.S. Cl. CPC G02B 6/102; G02B 6/29344

(57) ABSTRACT

Integrated photonic devices suitable for mid-wave infrared (MWIR) light and fabricated using a silicon photonics fabrication process platform are disclosed. A waveguide may include a germanium waveguiding region on a silicon layer, where the germanium waveguiding region and the silicon layer are surrounded by silicon dioxide cladding, and where widths of the germanium waveguiding region and the silicon layer are selected to provide guiding of light of a selected wavelength in a mid-wave infrared spectral range. Photonic devices may also include, but are not limited to, waveguides, phase shifters, edge couplers, or multi-mode interferometer devices.

### CROSS-REFERENCE TO RELATED APPLICATION

The present application claims the benefit under 35 U.S.C. § 119(e) of U.S. Provisional Application Ser. No. 63/674,076, filed Jul. 22, 2024, naming Milica Notaros and Moe D. Soltani as inventors, which is incorporated herein by reference in the entirety.

### TECHNICAL FIELD

The present disclosure relates generally to integrated photonic devices and, more particularly, to integrated photonic devices for mid-wave infrared wavelengths compatible with silicon photonics fabrication constraints.

### BACKGROUND

The field of integrated photonics has advanced rapidly due to wafer-scale fabrication, with integrated-photonics platforms and wafer-scale fabrication processes being demonstrated at both near-infrared and visible wavelengths. Beyond these more traditional wavelength ranges, operation at mid-wave infrared (MWIR) wavelengths enables many impactful application areas, such as chemical sensing and long-range imaging. While some integrated devices and systems have been demonstrated at MWIR wavelengths, they have been limited to chip-scale fabrication and thus have limited scalability for wide-spread use. There is therefore a need to develop systems and methods to address these deficiencies.

### SUMMARY

In embodiments, the techniques described herein relate to a waveguide including a germanium waveguiding region on a silicon layer, where the germanium waveguiding region and the silicon layer are surrounded by silicon dioxide cladding in directions orthogonal to a propagation direction, where widths of the germanium waveguiding region and the silicon layer are selected to provide guiding of light of a selected wavelength in a mid-wave infrared spectral range.

In embodiments, the techniques described herein relate to a waveguide, where the mid-wave infrared spectral range includes one or more wavelengths in a range of 2-6 micrometers.

In embodiments, the techniques described herein relate to a waveguide, where the selected wavelength is 4 micrometers.

In embodiments, the techniques described herein relate to a waveguide, where a width of the germanium waveguiding region is approximately 1.5 micrometers, where a width of the silicon layer is approximately 2 micrometers.

In embodiments, the techniques described herein relate to a waveguide, where a thickness of the germanium waveguiding region is approximately 800 micrometers, where a thickness of the silicon layer is approximately 220 micrometers.

In embodiments, the techniques described herein relate to a waveguide, further including a substrate, where a portion of the silicon dioxide cladding is provided as a layer between the substrate and the silicon layer.

In embodiments, the techniques described herein relate to a waveguide, where at least a portion of the silicon layer extends beyond the germanium waveguiding region along a direction orthogonal to the propagation direction and includes a doped region, where applying an electrical signal to the doped region of the silicon layer induces a heat distribution across the germanium waveguiding region and induces a phase shift of the light of the selected wavelength propagating through the germanium waveguiding region.

In embodiments, the techniques described herein relate to an edge coupler including a silicon nitride waveguide, where the silicon nitride waveguide includes one or more silicon nitride layers separated by silicon dioxide, where the silicon nitride waveguide is surrounded by silicon dioxide in directions orthogonal to a propagation direction, where a width of the silicon nitride waveguide increases along the propagation direction; a germanium waveguide including a germanium waveguiding region coupled to the silicon nitride waveguide; and a silicon layer beneath the germanium waveguiding region and extending beneath a portion of the silicon nitride waveguide, where widths of the germanium waveguiding region and the silicon layer increase along the propagation direction, where the widths of the silicon nitride waveguide, the germanium waveguiding region, and the silicon layer are selected to transition an optical mode of light of a selected wavelength in a mid-wave infrared spectral range from the silicon nitride waveguide to the germanium waveguide.

In embodiments, the techniques described herein relate to an edge coupler, where the widths of the silicon nitride waveguide, the germanium waveguiding region, and the silicon layer are selected to provide an adiabatic transition of the optical mode of light of the selected wavelength in the mid-wave infrared spectral range from the silicon nitride waveguide to the germanium waveguide.

In embodiments, the techniques described herein relate to an edge coupler, where the mid-wave infrared spectral range includes one or more wavelengths in a range of 2-6 micrometers.

In embodiments, the techniques described herein relate to an edge coupler, where the selected wavelength is 4 micrometers.

In embodiments, the techniques described herein relate to an edge coupler, where a thickness of the germanium waveguiding region is approximately 800 micrometers, where a thickness of the silicon layer is approximately 220 micrometers, where thicknesses of at least one of the one or more silicon nitride layers is approximately 220 micrometers.

In embodiments, the techniques described herein relate to an edge coupler, where the width of the germanium waveguiding region at an output is approximately 1.5 micrometers, where the width of the silicon layer at the output is approximately 2 micrometers.

In embodiments, the techniques described herein relate to an edge coupler, where widths of the one or more silicon nitride layers transition between 8 to 3.5 micrometers, where a width of the germanium waveguiding region transitions between 400 nanometers and 1.5 micrometers, where a length of the silicon nitride waveguide along the propagation direction is 30 micrometers, where a length of the germanium waveguiding region along the propagation direction is 30 micrometers.

In embodiments, the techniques described herein relate to an edge coupler, further including a substrate, where a portion of the silicon dioxide is provided as a layer between the substrate and the silicon layer.

In embodiments, the techniques described herein relate to a multi-mode interferometer including a germanium waveguiding region on a silicon layer, where the germanium waveguiding region and the silicon layer are surrounded by silicon dioxide in directions orthogonal to a waveguiding direction, where the germanium waveguiding region and the silicon layer form one or more first waveguides; a multi-mode interferometer region coupled to the one or more first waveguides at one end; and two or more second waveguides coupled to the multi-mode interferometer region at a second end, where widths of the two or more second waveguides are smaller than a width of the multi-mode interferometer region, where widths of the germanium waveguiding region and the silicon layer are selected to provide guiding of light of a selected wavelength in a mid-wave infrared spectral range.

In embodiments, the techniques described herein relate to a multi-mode interferometer, where the mid-wave infrared spectral range includes one or more wavelengths in a range of 2-6 micrometers.

In embodiments, the techniques described herein relate to a multi-mode interferometer, where a thickness of the germanium waveguiding region is approximately 800 micrometers, where a thickness of the silicon layer is approximately 220 micrometers.

In embodiments, the techniques described herein relate to a multi-mode interferometer, where widths of the one or more first waveguides and the widths of the two or more second waveguides transition from 2.3 micrometers to 1.5 micrometers in directions away from the multi-mode interferometer region, where a length of the multi-mode interferometer region along the waveguiding direction is 6 micrometers.

In embodiments, the techniques described herein relate to a multi-mode interferometer, further including a substrate, where a portion of the silicon dioxide is provided as a layer between the substrate and the silicon layer.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a cross-sectional view of a germanium waveguide, in accordance with one or more embodiments of the present disclosure.

FIG. 1B is a plot depicting an optical mode in a germanium waveguide, in accordance with one or more embodiments of the present disclosure.

FIG. 2A illustrates a cross-sectional view of a thermo-optic phase shifter, in accordance with one or more embodiments of the present disclosure.

FIG. 2B illustrates a plot of a cross-sectional heat distribution in a thermo-optic phase shifter, in accordance with one or more embodiments of the present disclosure.

FIG. 3A illustrates a top view of a MMI (multi-mode interferometer), in accordance with one or more embodiments of the present disclosure.

FIG. 3B is a plot of simulated transmission efficiency (on a scale of 0 to 1) as a function of the length of the MMI region.

FIG. 4A illustrates a schematic view of a MWIR edge coupler, in accordance with one or more embodiments of the present disclosure.

FIG. 4B illustrates a cross-sectional view of a silicon nitride waveguide with a single silicon nitride layer, in accordance with one or more embodiments of the present disclosure.

FIG. 4C illustrates a plot depicting an optical mode in a silicon nitride waveguide with a single silicon nitride layer, in accordance with one or more embodiments of the present disclosure.

FIG. 4D depicts a silicon nitride waveguide with two silicon nitride layers separated and surrounded by silicon dioxide cladding, in accordance with one or more embodiments of the present disclosure.

FIG. 4E illustrates a plot depicting a simulated optical mode in a dual silicon nitride waveguide with two silicon nitride layers, in accordance with one or more embodiments of the present disclosure.

FIG. 4F illustrates a plot depicting simulation results of the transmission of 4 micrometer light through the MWIR edge coupler shown in FIG. 4A, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to the design and fabrication of integrated photonic devices operating in a mid-wave infrared (MWIR) spectral range (e.g., at MWIR wavelengths) using a silicon photonics fabrication process. For the purposes of the present disclosure, the term MWIR refers to a spectral range of approximately 2-6 micrometers.

Design and fabrication of mid-wave infrared photonic devices on a standard silicon photonics fabrication platform has several constraints in terms of material layers thicknesses and their optical properties for mid-IR wavelength. Silicon photonic fabrication processes have been developed that provide photonic devices operating mainly at visible or near infrared (NIR) wavelengths such as wavelengths in various communications bands.

The silicon-on-insulator (SOI) fabrication process is one example of a silicon photonics fabrication platform suitable for fabrication of photonic devices operating at visible through NIR wavelengths (e.g., 700-1625 nanometers). In the SOI platform, waveguide structures are formed with a silicon (Si) core that is surrounded (e.g., encapsulated) by oxide materials such as silicon dioxide (SiO₂) as a cladding material. The silicon core materials provide compatibility with complementary-metal-oxide-semiconductor (CMOS) processes and also provide strong optical confinement for wavelengths typically used in communications applications such as wavelengths in the O, C, and L bands spanning approximately 1260-1625 nanometers. Further, the silicon dioxide cladding provides low optical loss for light extending into the cladding regions.

The SOI platform may also incorporate or be compatible with additional components. For example, detectors may be fabricated using materials that absorb wavelengths propagating through the waveguiding structures. As an illustration, germanium is commonly used as a detector material in SOI photonic devices since it offers strong absorption of NIR wavelengths and may be epitaxially grown on silicon. In some applications, other materials such as InGaAs or InP may be used as detector materials.

Embodiments of the present disclosure are directed to systems and methods providing MWIR photonic devices that may be fabricated using silicon photonics fabrication techniques such as, but not limited to, the SOI platform.

It is contemplated herein that designing MWIR photonic devices based on the SOI platform may be unexpected and counter-intuitive. For example, oxide materials such as silicon dioxide may have relatively high absorption for MWIR wavelengths and are thus not typically considered as suitable cladding materials since MWIR light extending into these cladding regions would be absorbed. Rather, typical MWIR photonic devices (e.g., those fabricated using existing chip-scale fabrication processes) may utilize air or another non-absorbing cladding material rather than an oxide material.

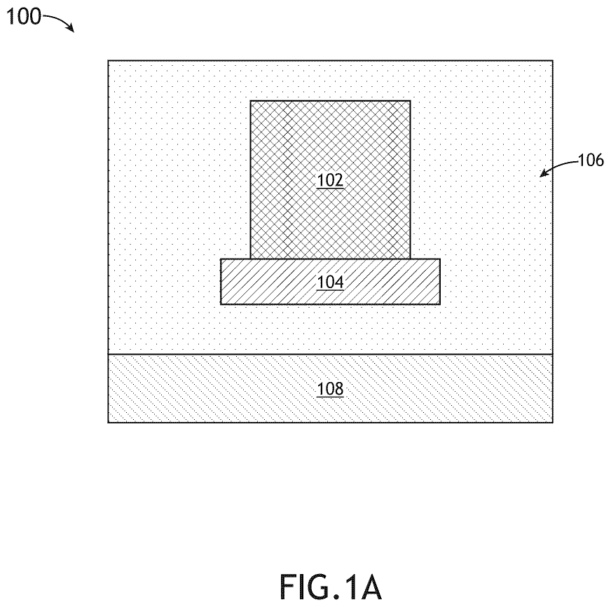

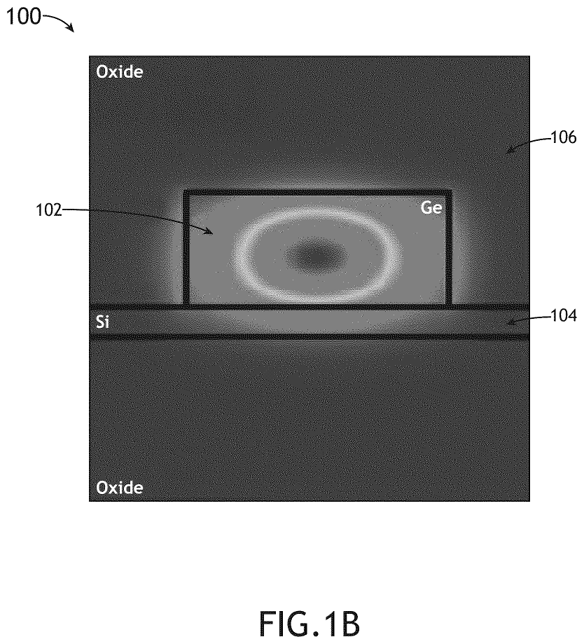

Referring now to FIGS. 1A-4F, MWIR photonic devices suitable for fabrication using silicon photonics fabrication processes are described in greater detail, in accordance with one or more embodiments of the present disclosure.

For example, some embodiments of the present disclosure are directed to MWIR waveguides, or waveguiding structures more generally, suitable for fabrication with a silicon photonics fabrication process.

FIG. 1A illustrates a cross-sectional view of a germanium waveguide 100, in accordance with one or more embodiments of the present disclosure.

In some embodiments, a germanium waveguide 100 suitable for guiding MWIR light includes a germanium waveguiding region 102 on a silicon layer 104 (e.g., a silicon platform), where the germanium waveguiding region 102 and the silicon layer 104 are surrounded (e.g., fully encapsulated) by a silicon dioxide cladding 106 in directions orthogonal to a propagation direction (e.g., orthogonal to the figure plane in FIG. 1A). Further, the germanium waveguide 100 may be fabricated on a substrate 108 formed from any material such as, but not limited to, silicon.

For example, a typical SOI fabrication process may include a silicon waveguide (e.g., as a simple silicon layer or as a ridge waveguide) surrounded by a silicon dioxide cladding on a silicon substrate. Such as SOI fabrication process may further include photodetectors formed by fabricating a layer of germanium on a silicon waveguide, where light propagating through the silicon waveguide may be absorbed by the germanium. Electrical contacts to the germanium and the silicon may allow for electrical readout of absorbed light.

Existing SOI platforms may incorporate material thicknesses and geometries that are suitable for visible through NIR wavelengths, but may not be directly suitable for MWIR wavelengths. For example, existing SOI platforms typically provide silicon layers on the order of a few hundred nanometers, which may result in low-confinement factors of MWIR light and thus high losses in the silicon dioxide cladding 106.

However, it is contemplated herein that the germanium on silicon fabrication processes typically used for photodetectors for visible-NIR light may be suitable for use as a waveguide for MWIR (e.g., as a germanium waveguide 100 shown in FIG. 1A). For example, the dimensions of the germanium waveguiding region 102 may be designed to provide high confinement of MWIR light to mitigate losses from the silicon dioxide cladding 106. In this way, although not typical, a germanium waveguide 100 may be fabricated using silicon photonics fabrication process-compatible techniques by fabricating a germanium waveguiding region 102 on a silicon layer 104 in an arbitrary pattern having dimensions suitable for waveguiding. Further, as will be described throughout the present disclosure, additional photonic devices may be fabricated using this germanium on silicon platform.

The materials forming germanium waveguide 100 may be fabricated with any dimensions suitable for providing desired optical performance (e.g., a desired confinement factor, a desired loss, or the like) and suitable for fabrication within a selected silicon photonics fabrication process. For example, the silicon layer 104 may have, but is not required to have, a thickness in a range of 100-300 nanometers. As another example, the germanium waveguiding region 102 may have, but is not required to have, a thickness in a range of 500-1500 nanometers. As another example, the silicon dioxide cladding 106 may have any thickness. In some cases, a portion of the silicon dioxide cladding 106 between the silicon layer 104 and the substrate 108 has a thickness of 1-10 micrometers (e.g., 2 micrometers). Similarly, the germanium waveguiding region 102 and the silicon layer 104 may have any widths suitable for providing the desired optical performance. It is contemplated herein that the optical properties may be generally dependent on the combination of the thickness and width of the constituent materials such that many designs are possible and within the scope of the present disclosure.

Referring now to FIG. 1B, the performance of a germanium waveguide 100 is described, in accordance with one or more embodiments of the present disclosure. In this example, the germanium waveguiding region 102 has a thickness of 800 nanometers and a width of 1.5 micrometers, while the silicon layer 104 has a typical thickness of ˜220 nanometers and a width of 2 micrometers. In this configuration, the silicon layer 104 extends 0.25 micrometers in directions transverse to a propagation direction.

FIG. 1B is a plot depicting an optical mode in a germanium waveguide 100, in accordance with one or more embodiments of the present disclosure. In particular, FIG. 1B illustrates an optical mode of MWIR light with a wavelength of 4 micrometers in a germanium waveguide 100 formed with a germanium waveguiding region 102 having a thickness of 800 nm and a silicon layer 104 having a thickness of 220 nm. As illustrated in FIG. 1B, the optical mode is tightly confined in the germanium waveguiding region 102 within minimal extension into the silicon dioxide cladding 106, which results in a simulated propagation loss (excluding sidewall roughness) of 0.4 dB/cm.

Some embodiments of the present disclosure are directed to a thermo-optic phase shifter, which may be suitable for, but not limited to, actively-tunable modulation. It is contemplated herein that germanium has a thermo-optic coefficient that is approximately 2.5 times stronger than silicon at an operating wavelength of 4 μm.

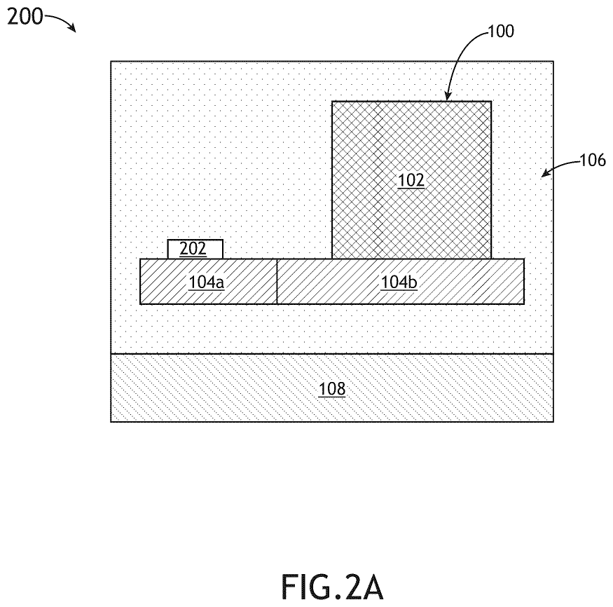

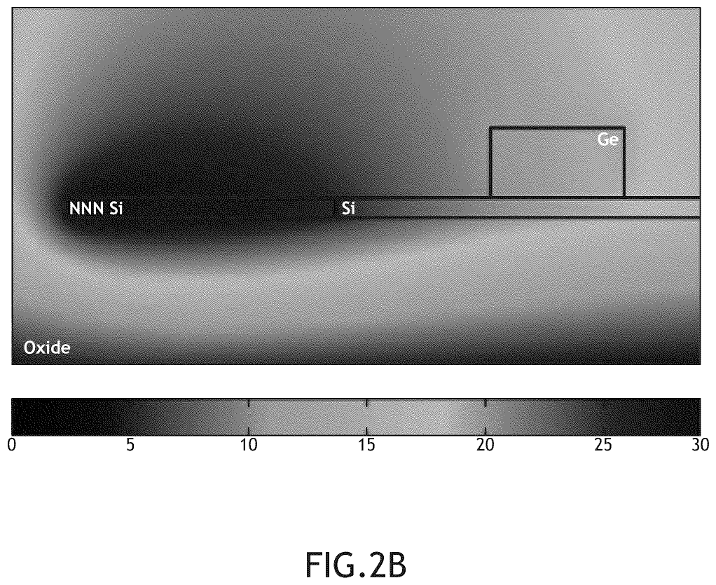

FIG. 2A illustrates a cross-sectional view of a thermo-optic phase shifter 200, in accordance with one or more embodiments of the present disclosure. In some embodiments, a thermo-optic phase shifter 200 includes a germanium waveguide 100 (e.g., as shown in FIG. 1A), where at least a portion of the silicon layer 104 is extended laterally in a direction orthogonal to a propagation direction and heavily doped to make a resistive heater. For example, FIG. 2A depicts an undoped silicon layer 104a beneath the germanium waveguiding region 102 and a doped silicon layer 104b extending away from the germanium waveguiding region 102 to provide resistive heating. The doped silicon layer 104b may have any dimensions and include any amount of doping sufficient to provide resistive heating suitable for a desired application. The thermo-optic phase shifter 200 may further include an electrical contact 202 contacting the silicon layer 104 (e.g., doped region of the silicon layer 104). In this configuration, an electrical signal applied to the doped silicon layer 104 (e.g., via the electrical contact 202) may provide a heat distribution across the germanium waveguide 100, which may induce a phase shift of light propagating through the germanium waveguide 100.

FIG. 2B illustrates a plot of a cross-sectional heat distribution in a thermo-optic phase shifter 200, in accordance with one or more embodiments of the present disclosure. In FIG. 2B, the doped region of the silicon layer 104 and the electrical contact 202 are placed 1.5 micrometers from the germanium waveguiding region 102. In this configuration, the thermal profile induced by an applied electrical signal across the germanium waveguiding region 102 is relatively constant, which may facilitate efficient and uniform phase shifting. More generally, the electrical contact 202 may be placed at any distance from the germanium waveguiding region 102 suitable for providing a desired heat distribution profile.

In some embodiments, though not explicitly shown, the thermo-optic phase shifter 200 may include multiple heater regions (e.g., electrical contacts 202) along a propagation direction in order to achieve a desired phase shift at a selected wavelength. For example, by dividing a 200-μm-long heater region into 4 electrical segments, simulation results show that 2π phase shift is achieved with a 5 V electrical signal. However, this is merely an illustration and should not be interpreted as limiting the scope of the present disclosure. A thermo-optic phase shifter 200 may include any number of heating sections with any distribution and at any separation distance from the germanium waveguiding region 102. In this way, the thermo-optic phase shifter 200 may be designed to provide any desired phase shift for any selected wavelength using any applied voltage.

It is contemplated herein that a wide range of photonic structures may be fabricated using variations of the germanium waveguide 100 disclosed herein such as, but not limited to, couplers and splitters.

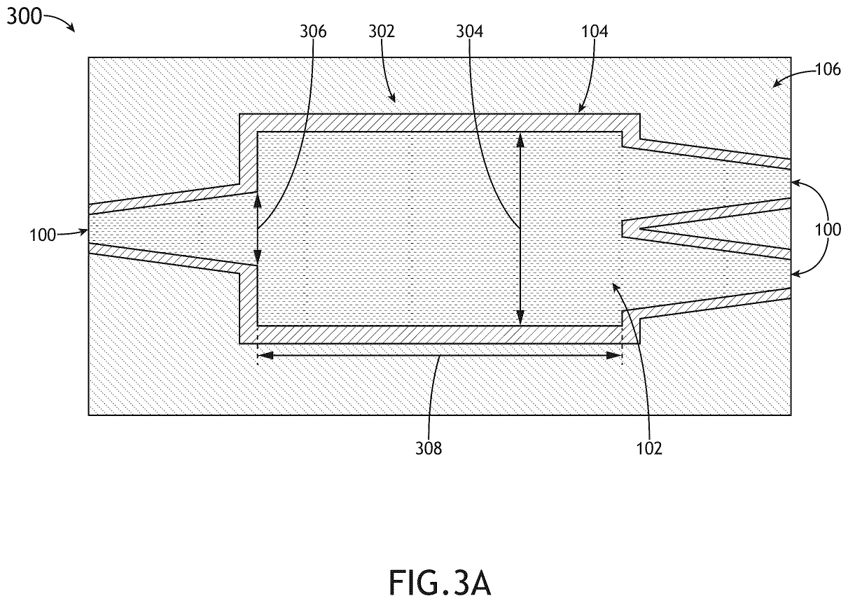

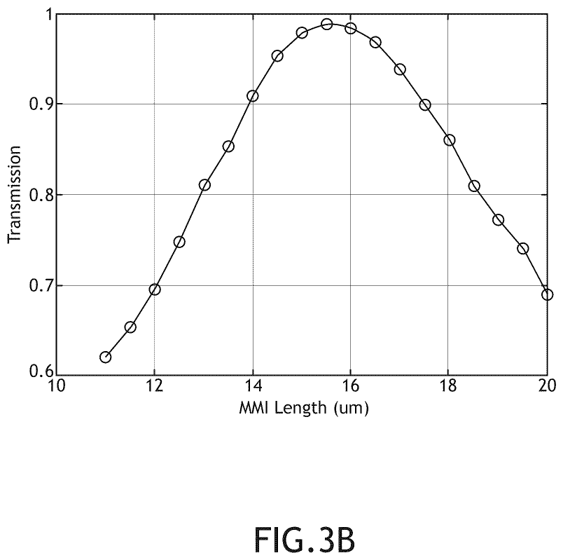

FIG. 3A illustrates a top view of a MMI 300 (multi-mode interferometer), in accordance with one or more embodiments of the present disclosure. In particular, the MMI 300 in FIG. 3A is fabricated using a germanium waveguiding region 102 on a silicon layer 104 surrounded by a silicon dioxide cladding 106 as described with respect to the germanium waveguide 100. In this way, the MMI 300 may also be fabricated using silicon photonics fabrication processes and suitable for operation at MWIR wavelengths.

The MMI 300 may have any number of connected waveguides (e.g., germanium waveguides 100) and may thus be suitable for any splitting or beam combining application. For example, FIG. 3A depicts a 1×2 MMI 300 with a single germanium waveguide 100 on one side of a MMI region 302 and two germanium waveguides 100 on an opposing side of the MMI region 302. In this way, combined widths of the germanium waveguides 100 on either end of the MMI region 302 may be smaller than a width 304 of the MMI region 302. Such a configuration may be suitable for, but not limited to, splitting or combining MWIR light.

The MMI region 302 as well as the germanium waveguides 100 may have any suitable dimensions selected to provide a desired optical performance and further maintain compatibility with a selected silicon photonics fabrication process. For example, an MMI region 302 width 304 of 6 micrometers may be selected to support a few higher-order modes in the MMI region 302. Further, widths 306 of 2.3 micrometers for the germanium waveguides 100 may be selected to excite the first few higher-order modes in the MMI region 302. As shown in FIG. 3A, this width 306 may taper away from the MMI region 302 to any waveguide width. Finally, the length 308 of the MMI region 302 may be selected to maximize transmission through the MMI 300 as a whole. FIG. 3B is a plot of simulated transmission efficiency (on a scale of 0 to 1) as a function of the length 308 of the MMI region 302. As an illustration, selecting a length 308 of the MMI region 302 to be 15.6 micrometers may provide a simulated transmission efficiency of 0.988 (98.8%).

It is to be understood that FIGS. 3A-3B are provided solely for illustrative purposes and should not be interpreted as limiting the scope of the present disclosure. A splitter, combiner, or interferometer formed using germanium on silicon may have any design or dimensions that are compatible with a selected silicon photonics fabrication process.

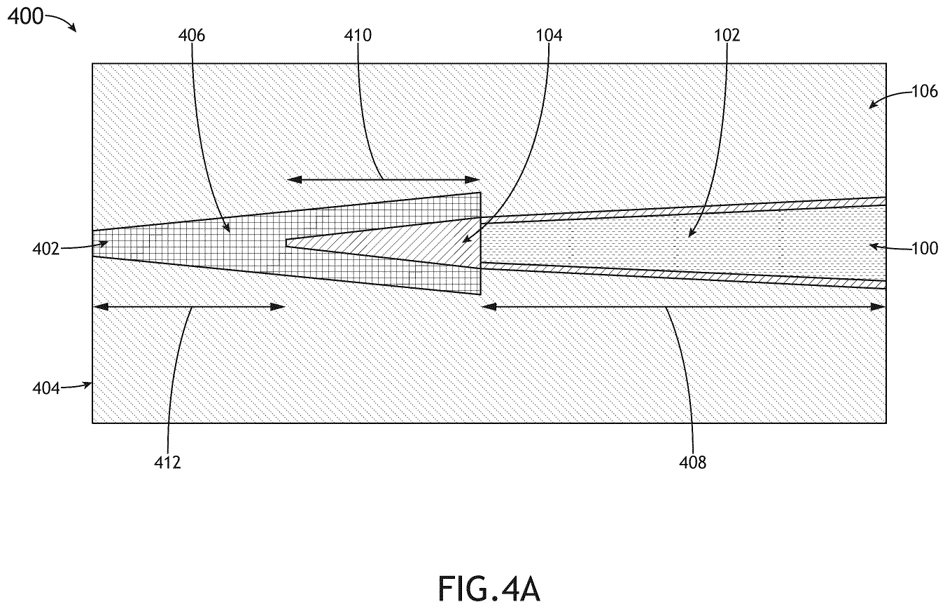

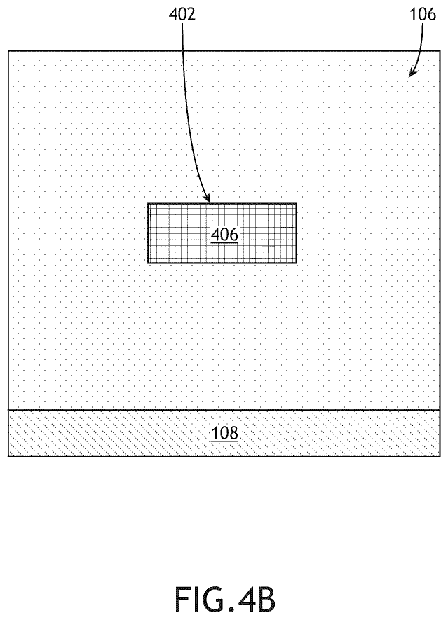

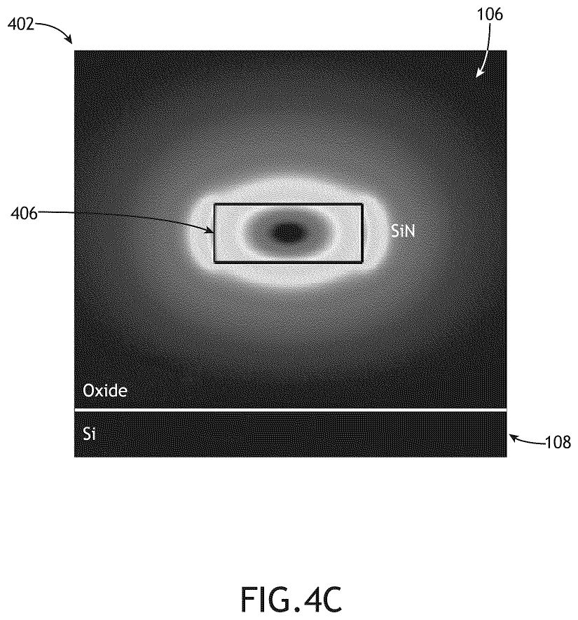

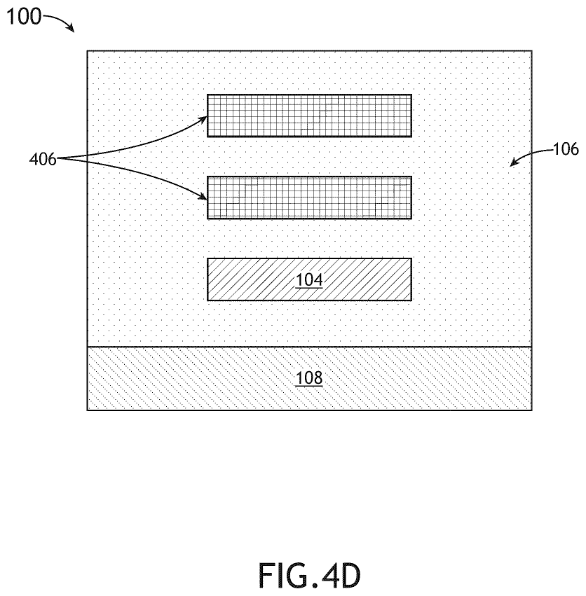

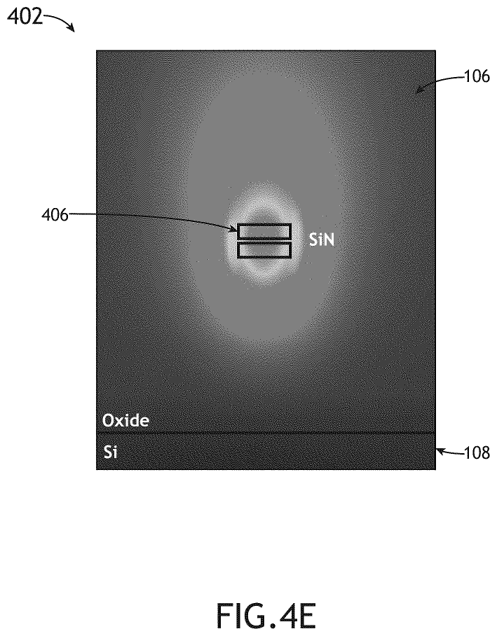

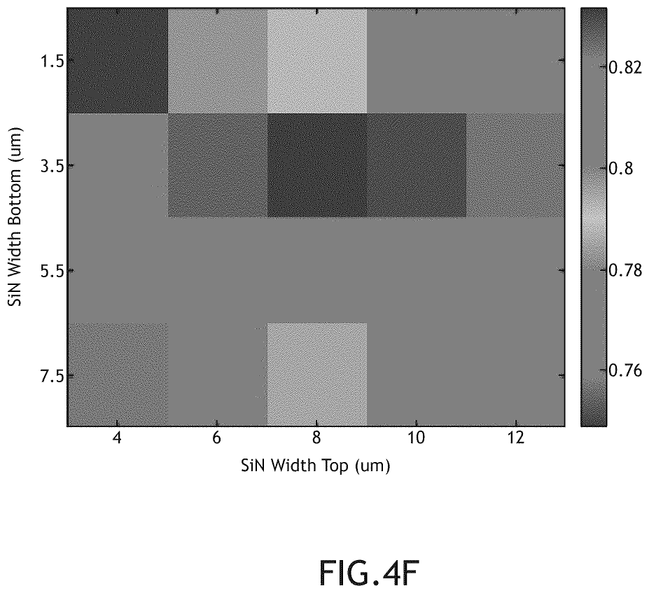

Referring now to FIGS. 4A-4F, techniques for coupling light into or out of a germanium waveguide 100 are described, in accordance with one or more embodiments of the present disclosure.

Some embodiments of the present disclosure are directed to MWIR couplers (e.g., edge couplers) designed to facilitate coupling between a germanium waveguide 100 and an external device (e.g., an off-chip device) such as, but not limited to, an optical fiber. It is contemplated herein that it may be impracticable to directly couple MWIR light between an optical fiber and a germanium waveguide 100 due to a relatively large mode field diameter of typical MWIR optical fibers, the high mode confinement in the germanium waveguide 100, the relatively high loss in the silicon dioxide cladding 106, and a proximity of the substrate 108. For example, a mode field diameter of 4 micrometer light in a typical fluoroindate optical fiber is approximately 12 micrometers.

FIG. 4A illustrates a schematic view of a MWIR edge coupler 400, in accordance with one or more embodiments of the present disclosure.

In some embodiments, a MWIR edge coupler 400 transitions between a germanium waveguide 100 and a silicon nitride waveguide 402 that may be coupled to an end face 404 of a photonic device (e.g., a chip fabricated using a silicon photonics fabrication process). In this configuration, the silicon nitride waveguide 402 may be configured to facilitate efficient mode coupling with an external device such as an optical fiber.

A silicon nitride waveguide 402 may generally include any number of silicon nitride layers 406 separated and surrounded by silicon dioxide cladding 106. FIG. 4B illustrates a cross-sectional view of a silicon nitride waveguide 402 with a single silicon nitride layer 406, in accordance with one or more embodiments of the present disclosure. FIG. 4C illustrates a plot depicting an optical mode in a silicon nitride waveguide 402 with a single silicon nitride layer 406, in accordance with one or more embodiments of the present disclosure. In particular, FIG. 4C illustrates an optical mode of MWIR light with a wavelength of 4 micrometers in a single silicon nitride layer 406 surrounded by silicon dioxide cladding 106. Further, the silicon nitride waveguide 402 simulated in FIG. 4C does not include a silicon layer 104.

FIG. 4D depicts a silicon nitride waveguide 402 with two silicon nitride layers 406 separated and surrounded by silicon dioxide cladding 106 (e.g., a dual silicon nitride waveguide), in accordance with one or more embodiments of the present disclosure. It is contemplated that a number and thickness of such layers may be influenced or determined by a selected silicon photonics fabrication process. In some cases, the silicon nitride layers 406 have thicknesses of 220 nanometers and may be separated by 100 nanometer layers of silicon dioxide cladding 106. However, this is merely illustrative and should not be interpreted as limiting the scope of the present disclosure. Further, as shown in FIG. 4D, a silicon nitride waveguide 402 may optionally include a silicon layer 104.

FIG. 4E illustrates a plot depicting a simulated optical mode in a dual silicon nitride waveguide 402 with two silicon nitride layers 406, in accordance with one or more embodiments of the present disclosure. In the simulation shown in FIG. 4E, the two silicon nitride layers 406 each have a thickness of 220 nm, are separated by 100 nm, and have widths of 1.7 micrometers. Further, the silicon nitride waveguide 402 simulated in FIG. 4E does not include a silicon layer 104. As shown by a comparison of FIG. 4E with FIG. 1B, 4 micrometer light is relatively less confined in the silicon nitride waveguide 402 than in the germanium waveguide 100 and may achieve a 62.6% mode overlap with a fluoroindate optical fiber. In this example, one limiting factor to achieving greater mode overlap is the relative proximity of a silicon substrate 108 that was 2.32 micrometers below the silicon nitride waveguide 402, which was associated with a constraint imposed by a silicon photonics fabrication process considered by this example. It is contemplated that higher mode overlaps may be achievable through other designs and/or other silicon photonics fabrication processes with different constraints.

Referring again to FIG. 4A, the MWIR edge coupler 400 may transition between a germanium waveguide 100 and a silicon nitride waveguide 402 through one or more transition regions in which the presence and/or widths of various materials is varied at a rate that provides gradual mode transitions.

For example, FIG. 4A illustrates a first region 408 including a germanium waveguide 100, a second region 410 including a dual silicon nitride waveguide 402 with a silicon layer 104, and a third region 412 including a dual silicon nitride waveguide 402 without a silicon layer 104. In this configuration, light propagating through the MWIR edge coupler 400 may transition from relatively high confinement in the germanium waveguiding region 102 of the germanium waveguide 100 to relatively weak confinement and large mode profile in the silicon nitride waveguide 402 for external coupling. The MWIR edge coupler 400 may further provide bidirectional operation in which light may propagate in either direction.

The first region 408, the second region 410, and the third region 412 may have any suitable design. For example, as shown in FIG. 4A, widths of both the germanium waveguiding region 102 and the silicon layer 104 in the first region 408 may gradually decrease for light propagating towards the silicon nitride waveguide 402. In this configuration, the decreasing widths may gradually reduce a confinement factor of light in the germanium waveguiding region 102, which may cause an increase in the optical mode profile. The second region 410 may then include a dual silicon nitride waveguide 402 in which the widths of the two silicon nitride layers 406 and the silicon layer 104 are designed to promote efficient coupling with the germanium waveguide 100 in the first region 408. These material widths may then gradually reduce through the second region 410 until the silicon layer 104 terminates (e.g., until the silicon layer 104 terminates to a minimum width achievable in a fabrication process). In the third region 412, the widths of the dual silicon nitride layers 406 may continue to decrease until a desired optical mode profile is achieved at the end face 404. Again, it is emphasized that the MWIR edge coupler 400 may provide bidirectional operation such that the optical mode of light may undergo the reverse changes in the opposite propagation direction.

FIG. 4F illustrates a plot depicting simulation results of the transmission of 4 micrometer light through the MWIR edge coupler 400 shown in FIG. 4A, in accordance with one or more embodiments of the present disclosure. The material widths throughout the MWIR edge coupler 400 may be varied with any profile. For example, the widths of any of the materials may vary linearly or with a selected curved profile. In some cases, the widths may be adiabatically tapered to provide smooth and efficient transitioning of the optical mode. Further, the lengths of the tapered regions may be selected to provide a desired overall efficiency and/or balance various sources of loss. For example, efficient mode transitioning may generally be achieved through adiabatic tapering over long lengths. However, as described throughout the present disclosure, the silicon dioxide cladding 106 used as a cladding structure in many silicon photonics fabrication processes may absorb MWIR light such that it may also be desirable to minimize a length of the MWIR edge coupler 400 generally and the third region 412 in particular. Accordingly, the lengths of the various regions of the MWIR edge coupler 400 as well as the width transition profiles may be selected to balance smooth optical mode transitions with losses in the silicon nitride waveguides 402. In some embodiments, an overall transmission efficiency of 83.2% may be achieved with a design providing 30 micrometer taper lengths for both the two silicon nitride layers 406 and the germanium waveguiding region 102, a 15 micrometer taper length for the silicon layer 104, widths of the silicon nitride layers 406 that transition between 8 and 3.5 micrometers, and widths of the germanium waveguiding region 102 that transition between 400 nm and 1.5 micrometers (e.g., at an output end). It is to be understood, however, that this is merely an illustration and should not be interpreted as limiting the scope of the present disclosure.

The following references are incorporated by reference in their entireties: E. Timurdogan et al., “AIM Process Design Kit (AIMPDKv2.0): Silicon Photonics Passive and Active Component Libraries on a 300 mm Wafer,” in Optical Fiber Communication Conference (OFC), OSA Technical Digest (Optica Publishing Group, 2018) paper M3F.1; M. Notaros et al., “Integrated visible-light liquid-crystal-based phase modulators,” Opt. Express 30(8), 13790-13801 (2022); J. A. Hackwell et al., “LWIR/MWIR imaging hyperspectral sensor for airborne and ground-based remote sensing,” in Imaging Spectrometry II, (SPIE, 1996), pp. 102-107; V. Singh et al., “Mid-infrared materials and devices on a Si platform for optical sensing,” Sci. Technol. Adv. 15(1), 014603 (2014); H. Lin et al., “Mid-infrared integrated photonics on silicon: a perspective,” Nanophotonics 7(2), 393-420 (2017); M. Prost et al., “Solid-state MWIR beam steering using optical phased array on germanium-silicon photonic platform,” IEEE Photonics J. 11(6), 1-9 (2019); S. Khan et al., “Silicon-on-nitride waveguides for mid- and near-infrared integrated photonics,” Appl. Phys. Lett. 102(12) (2013); and B. Frey et al., “Temperature-dependent refractive index of silicon and germanium,” in Optomechanical Technologies for Astronomy, (SPIE, 2006), pp. 790-799.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A waveguide comprising:
a germanium waveguiding region on a silicon layer, wherein the germanium waveguiding region and the silicon layer are surrounded by silicon dioxide cladding in directions orthogonal to a propagation direction, wherein widths of the germanium waveguiding region and the silicon layer are selected to provide guiding of light of a selected wavelength in a mid-wave infrared spectral range.

2. The waveguide of claim 1, wherein the mid-wave infrared spectral range includes one or more wavelengths in a range of 2-6 micrometers.

3. The waveguide of claim 1, wherein the selected wavelength is 4 micrometers.

4. The waveguide of claim 1, wherein a width of the germanium waveguiding region is approximately 1.5 micrometers, wherein a width of the silicon layer is approximately 2 micrometers.

5. The waveguide of claim 1, wherein a thickness of the germanium waveguiding region is approximately 800 micrometers, wherein a thickness of the silicon layer is approximately 220 micrometers.

6. The waveguide of claim 1, further comprising a substrate, wherein a portion of the silicon dioxide cladding is provided as a layer between the substrate and the silicon layer.

7. The waveguide of claim 1, wherein at least a portion of the silicon layer extends beyond the germanium waveguiding region along a direction orthogonal to the propagation direction and includes a doped region, wherein applying an electrical signal to the doped region of the silicon layer induces a heat distribution across the germanium waveguiding region and induces a phase shift of the light of the selected wavelength propagating through the germanium waveguiding region.

8. An edge coupler comprising:
a silicon nitride waveguide, wherein the silicon nitride waveguide comprises one or more silicon nitride layers separated by silicon dioxide, wherein the silicon nitride waveguide is surrounded by silicon dioxide in directions orthogonal to a propagation direction, wherein a width of the silicon nitride waveguide increases along the propagation direction;
a germanium waveguide including a germanium waveguiding region coupled to the silicon nitride waveguide; and
a silicon layer beneath the germanium waveguiding region and extending beneath a portion of the silicon nitride waveguide, wherein widths of the germanium waveguiding region and the silicon layer increase along the propagation direction, wherein the widths of the silicon nitride waveguide, the germanium waveguiding region, and the silicon layer are selected to transition an optical mode of light of a selected wavelength in a mid-wave infrared spectral range from the silicon nitride waveguide to the germanium waveguide.

9. The edge coupler of claim 8, wherein the widths of the silicon nitride waveguide, the germanium waveguiding region, and the silicon layer are selected to provide an adiabatic transition of the optical mode of light of the selected wavelength in the mid-wave infrared spectral range from the silicon nitride waveguide to the germanium waveguide.

10. The edge coupler of claim 8, wherein the mid-wave infrared spectral range includes one or more wavelengths in a range of 2-6 micrometers.

11. The edge coupler of claim 8, wherein the selected wavelength is 4 micrometers.

12. The edge coupler of claim 8, wherein a thickness of the germanium waveguiding region is approximately 800 micrometers, wherein a thickness of the silicon layer is approximately 220 micrometers, wherein thicknesses of at least one of the one or more silicon nitride layers is approximately 220 micrometers.

13. The edge coupler of claim 8, wherein the width of the germanium waveguiding region at an output is approximately 1.5 micrometers, wherein the width of the silicon layer at the output is approximately 2 micrometers.

14. The edge coupler of claim 13, wherein widths of the one or more silicon nitride layers transition between 8 to 3.5 micrometers, wherein a width of the germanium waveguiding region transitions between 400 nanometers and 1.5 micrometers, wherein a length of the silicon nitride waveguide along the propagation direction is 30 micrometers, wherein a length of the germanium waveguiding region along the propagation direction is 30 micrometers.

15. The edge coupler of claim 13, further comprising a substrate, wherein a portion of the silicon dioxide is provided as a layer between the substrate and the silicon layer.

16. A multi-mode interferometer comprising:
a germanium waveguiding region on a silicon layer, wherein the germanium waveguiding region and the silicon layer are surrounded by silicon dioxide in directions orthogonal to a waveguiding direction, wherein the germanium waveguiding region and the silicon layer form:
one or more first waveguides;
a multi-mode interferometer region coupled to the one or more first waveguides at one end; and
two or more second waveguides coupled to the multi-mode interferometer region at a second end, wherein widths of the two or more second waveguides are smaller than a width of the multi-mode interferometer region, wherein widths of the germanium waveguiding region and the silicon layer are selected to provide guiding of light of a selected wavelength in a mid-wave infrared spectral range.

17. The multi-mode interferometer of claim 16, wherein the mid-wave infrared spectral range includes one or more wavelengths in a range of 2-6 micrometers.

18. The multi-mode interferometer of claim 16, wherein a thickness of the germanium waveguiding region is approximately 800 micrometers, wherein a thickness of the silicon layer is approximately 220 micrometers.

19. The multi-mode interferometer of claim 16, wherein widths of the one or more first waveguides and the widths of the two or more second waveguides transition from 2.3 micrometers to 1.5 micrometers in directions away from the multi-mode interferometer region, wherein a length of the multi-mode interferometer region along the waveguiding direction is 6 micrometers.

20. The multi-mode interferometer of claim 16, further comprising a substrate, wherein a portion of the silicon dioxide is provided as a layer between the substrate and the silicon layer.
